(19) United States
(12) Patent Application Publication
(10) Pub. No.: US 2019/0180126 A1
(43) Pub. Date: Jun. 13, 2019

(54) STATE ESTIMATION APPARATUS, METHOD, AND NON-TRANSITORY RECORDING MEDIUM

(71) Applicant: OMRON Corporation, Kyoto-shi (JP)

(72) Inventors: Koichi KINOSHITA, Kyoto-shi (JP); Shunji OTA, Kasugai-shi (JP)

(73) Assignee: OMRON Corporation, Kyoto-shi (JP)

(21) Appl. No.: 16/215,467

(22) Filed: Dec. 10, 2018

(30) Foreign Application Priority Data
Dec. 13, 2017 (JP) 2017-238756

(51) Int. Cl. G06K 9/00

(52) U.S. Cl. CPC G06K 9/00845; G06K 9/00255

(57) ABSTRACT

The state of a driver driving a vehicle is easily determined. A state estimation apparatus includes an image selection unit that selects at least one monitoring image for use in estimating a state of a target person from a plurality of monitoring images of a target person captured by a plurality of cameras installed at different positions, a state estimation unit that estimates the state of the target person based on the selected monitoring image, and an output unit that outputs information indicating an estimation result.

### CROSS-REFERENCE TO RELATED APPLICATION

This application claims priority to Japanese Patent Application No. 2017-238756 filed on Dec. 13, 2017, the entire disclosure of which is incorporated herein by reference.

### FIELD

Embodiments of the present invention relate to a state estimation apparatus that estimates the state of a target person, such as a vehicle driver or a driver or an operator of machinery, and a method and a non-transitory recording medium having a program for such estimation.

### BACKGROUND

For example, vehicle drivers need to be fully awake while driving a vehicle. Besides vehicle drivers, for example, drivers or operators of machinery at manufacturing facilities or plants also need to be fully awake while driving or operating the machinery.

Vehicle drivers, or drivers or operators of machinery also need to be concentrating fully on driving a vehicle or operating machinery without being distracted or looking aside.

To achieve this, a variety of devices have been developed for alerting a driver or an operator determined to be engaging in drowsy driving or distracted driving. For example, Patent Literature 1 describes a technique for estimating a drowsy state of a person by generating an alarm from a speaker and detecting a change in the facial expression or the face or gaze direction of the person reacting to the alarm. Patent Literature 2 describes a technique for estimating a distracted state of a driver by detecting the driver's face or gaze direction and comparing the detected direction with a reference value.

### CITATION LIST

### Patent Literature

Patent Literature 1: Japanese Patent No. 5056067

Patent Literature 2: Japanese Unexamined Patent Application Publication No. 8-207617

### SUMMARY

### Technical Problem

The techniques described in Patent Literature 1 and Patent Literature 2 use a detection result of the facial expression or the face or gaze direction of a target person from his or her facial image captured by a single camera to estimate the state of the target person.

However, such a state estimation apparatus including a single camera may not detect the facial expression or face or gaze direction of a target person depending on his or her posture or face orientation. For a vehicle driver as a target person, the camera may capture an image of the driver's face hidden by an arm of the driver operating the steering wheel placed between the camera and the driver's face. The camera may not capture an image of the eyes or mouth of the driver while the driver's face is facing in directions other than the front of the camera. The state of the eyes or mouth is featuring information in estimating the driver state, and thus a failure to obtain such state information lowers the reliability of the state estimation.

As described above, a state estimation apparatus with such known techniques may not estimate the state of a target person depending on the conditions of the target person, or may estimate the state with less reliability. A state estimation apparatus desirably yields stable state estimation results independently of the conditions of a target person.

In response to the above issue, one or more aspects of the present invention are directed to a state estimation apparatus that estimates the state of a target person in any conditions in a stable manner, and a method and a non-transitory recording medium having a program for such estimation.

### Solution to Problem

A state estimation apparatus according to a first aspect of the present invention includes an image selection unit that selects at least one monitoring image for use in estimating a state of a target person from a plurality of monitoring images of the target person captured by a plurality of cameras placed at different positions, a state estimation unit that estimates the state of the target person based on the selected monitoring image, and an output unit that outputs information indicating an estimation result.

In the state estimation apparatus according to the first aspect, the image selection unit selects at least one monitoring image for state estimation from multiple monitoring images of a target person captured by multiple cameras placed at different positions to capture images of the target person from different positions. The state estimation unit estimates the state of the target person based on the selected monitoring image, and the output unit outputs information indicating the estimation result. Although a monitoring image captured by one camera cannot be used for estimating the state of a target person, a monitoring image captured by another camera may be used for estimating the state of the target person. This apparatus can thus estimate the state of the state of the target person in any conditions in a stable manner.

A state estimation apparatus according to a second aspect of the present invention is the apparatus according to the first aspect in which the image selection unit selects a monitoring image containing a face of the target person from the plurality of monitoring images.

The state estimation apparatus according to the second aspect can estimate the state of the target person in any conditions based on the selected monitoring image containing the face of the target person.

A state estimation apparatus according to a third aspect of the present invention is the apparatus according to the first or second aspect in which the image selection unit selects a monitoring image containing an eye of the target person from the plurality of monitoring images.

The state estimation apparatus according to the third aspect selects a monitoring image containing one or both eyes of the target person, which is featuring information to be used in estimating the state of the target person. The apparatus can thus estimate the state of the target person in a stable manner.

A state estimation apparatus according to a fourth aspect of the present invention is the apparatus according to any one of the first to third aspects in which the image selection unit selects a monitoring image containing two eyes of the target person from the plurality of monitoring images.

The state estimation apparatus according to the fourth aspect selects a monitoring image containing two eyes of the target person, and estimates the state of the target person based on the selected monitoring image. The apparatus can thus obtain reliable estimation results.

A state estimation apparatus according to a fifth aspect of the present invention is the apparatus according to any one of the first to fourth aspects in which when selecting a plurality of the monitoring images, the image selection unit selects, from the plurality of selected monitoring images, one monitoring image capturing the target person with a face oriented closest to a front.

The state estimation apparatus according to the fifth aspect selects, from the monitoring images, one monitoring image capturing the target person with the face oriented closest to the front, and estimates the state of the target person based on the selected monitoring image. The apparatus can easily estimate the state of the target person based on the monitoring image containing the face oriented in the forward direction, and thus obtain a highly reliable estimation result.

A state estimation apparatus according to a sixth aspect of the present invention is the apparatus according to the first aspect in which the image selection unit selects all monitoring images each containing two eyes of the target person, and the state estimation unit estimates the state of the target person based on each of the selected monitoring images, and provides an average of resultant estimates as an estimation result for the state of the target person.

The state estimation apparatus according to the sixth aspect estimates the target state based on each monitoring image containing the two eyes of the target person, and provides the average of the resultant estimates as an estimation result for the state of the target person. The state estimation apparatus can thus obtain a highly reliable final estimation result.

A state estimation apparatus according to a seventh aspect of the present invention is the apparatus according to the first aspect in which when finding no monitoring image containing two eyes of the target person, the image selection unit selects all monitoring images each containing one eye of the target person, and the state estimation unit estimates the state of the target person based on each of the selected monitoring images, and provides an average of resultant estimates as an estimation result for the state of the target person.

The state estimation apparatus according to the seventh aspect estimates the target state based on each monitoring image containing one eye of the target person when finding no monitoring images containing the two eyes of the target person, and provides the average of the resultant estimates as an estimation result for the state of the target person. The state estimation apparatus can thus obtain a more reliable estimation result than an estimation result obtained from one monitoring image containing one eye of the target person.

A state estimation apparatus according to an eighth aspect of the present invention is the apparatus according to the seventh aspect in which when the number of selected monitoring images is less than a predetermined number, the image selection unit further selects, from the monitoring images each containing no eye of the target person, one or more monitoring images in order from a monitoring image capturing the target person with a face oriented closer to a front to add up to the predetermined number.

The state estimation apparatus according to the eighth aspect further selects one or more monitoring images for state estimation in order from a monitoring image capturing the target person with the face oriented closer to the front when the number of monitoring images each containing one eye of the target person is less than intended. The state estimation apparatus can thus obtain a more reliable estimation result than an estimation result obtained from one monitoring image containing one eye of the target person.

A state estimation apparatus according to a ninth aspect of the present invention is the apparatus according to the first aspect in which when finding no monitoring image containing an eye or two eyes of the target person, the image selection unit selects, from the monitoring images each containing no eye of the target person, a predetermined number of monitoring images in order from a monitoring image capturing the target person with a face oriented closer to a front.

The state estimation apparatus according to the ninth aspect selects, when finding no monitoring image containing an eye or two eyes of the target person, a predetermined number of monitoring images in order from a monitoring image capturing the target person with the face oriented closer to the front from the monitoring images each containing no eye of the target person, and estimates the state of the target person based on the selected images. The state estimation apparatus can thus obtain a fairly reliable estimation result based on a predetermined number of monitoring images appropriate for state estimation using the facial expression of the target person, selected from the monitoring images each containing no eye of the target person.

A state estimation method according to a tenth aspect of the present invention is implemented by a state estimation apparatus that estimates a state of a target person. The method includes selecting, with the state estimation apparatus, at least one monitoring image for use in estimating the state of the target person from a plurality of monitoring images of the target person captured by a plurality of cameras placed at different positions, estimating, with the state estimation apparatus, the state of the target person based on the selected monitoring image, and outputting, with the state estimation apparatus, information indicating an estimation result.

The state estimation method according to the tenth aspect selects, as with the apparatus according to the first aspect, at least one monitoring image for state estimation from multiple monitoring images of a target person captured by multiple cameras, estimates the state of the target person based on the selected monitoring image, and outputs information indicating the estimation result. Although a monitoring image captured by one camera cannot be used for estimating the state of a target person, a monitoring image captured by another camera may be used for estimating the state of the target person. This method allows stable estimation of the state of the target person in any conditions.

A non-transitory recording medium according to an eleventh aspect of the present invention records a state estimation program causing a computer to function as the units included in the state estimation apparatus according to any one of the first to ninth aspects.

The non-transitory recording medium according to the eleventh aspect of the present invention allows a computer to implement any one of the first to ninth aspects.

### Advantageous Effects

The state estimation apparatus, method, and non-transitory recording medium according to the aspects of the present invention allow stable estimation of the state of a target person in any conditions.

### BRIEF DESCRIPTION OF THE DRAWINGS

FIG. 1 is block diagram describing an example use of a state estimation apparatus according to one embodiment of the present invention.

FIG. 2 is a schematic diagram describing the arrangement of multiple cameras.

FIG. 3 is a block diagram of the state estimation apparatus according to a first embodiment of the invention showing its hardware configuration.

FIG. 4 is a block diagram of a state estimation system of the state estimation apparatus according to the first embodiment of the invention showing its software configuration.

FIG. 5 is a flowchart showing an example procedure and operation performed by an image selection unit in the state estimation apparatus shown in FIG. 4.

FIG. 6 is a flowchart showing an example procedure and operation performed by a state estimation unit in the state estimation apparatus shown in FIG. 4.

FIG. 7 is a block diagram of a state estimation apparatus according to a second embodiment of the invention showing its software configuration.

FIG. 8 is a flowchart showing an example procedure and operation performed by an image selection unit in the state estimation apparatus shown in FIG. 7.

FIG. 9 is a flowchart showing an example procedure and operation performed by a state estimation unit in the state estimation apparatus shown in FIG. 7.

### DETAILED DESCRIPTION

One or more embodiments of the present invention will now be described with reference to the drawings.

### Example Use

One example use of a state estimation apparatus according to one embodiment of the present invention will now be described.

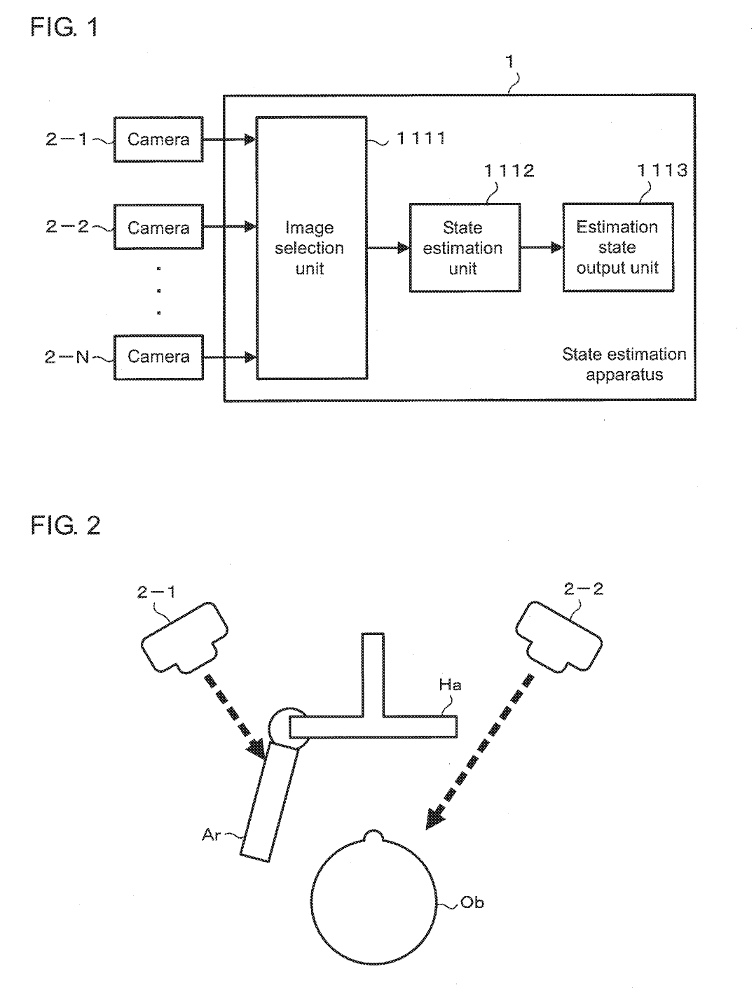

FIG. 1 is a block diagram of the state estimation apparatus in this example.

The state estimation apparatus 1 includes an image selection unit 1111, a state estimation unit 1112, and an estimation state output unit 1113. The state estimation apparatus 1 is connected to multiple (N) cameras 2-1, 2-2, . . . , and 2-N(N is an integer greater than or equal to two). These cameras 2-1, 2-2, . . . , and 2-N are installed to capture images of the face of a target person from different positions to obtain monitoring images of the target person.

FIG. 2 is a schematic diagram describing the arrangement of the cameras 2-1 and 2-2, among the cameras 2-1, 2-2, . . . , and 2-N. In the present embodiment, the target person is a vehicle driver Ob. Although one of the cameras, for example the camera 2-1, has an image capturing view blocked by an arm Ar of the driver Ob operating a steering wheel Ha, another camera, for example the camera 2-2, captures an image of the face of the driver Ob. The cameras 2-1, 2-2, . . . , and 2-N are thus placed to capture images of the face of the driver Ob from different positions. These cameras 2-1, 2-2, . . . , and 2-N may each be installed, for example, on the dashboard, at the center of the steering wheel, beside the speed meter, or on a front pillar. The cameras 2-1, 2-2, . . . , and 2-N may be still cameras that capture multiple still images of the driver Ob per second, or video cameras that capture moving images of the driver Ob.

The image selection unit 1111 selects at least one monitoring image for state estimation from multiple monitoring images of the driver Ob obtained by the cameras 2-1, 2-2, . . . , and 2-N placed at different positions.

For example, the image selection unit 1111 selects one monitoring image containing the face of the driver Ob from multiple monitoring images captured by the cameras 2-1, 2-2, . . . , and 2-N. The image selection unit 1111 may select, from the monitoring images, one or more monitoring images each containing an eye of the driver Ob, or specifically one or more monitoring images containing the two eyes of the driver Ob. The image selection unit 1111 can select, from multiple monitoring images each containing the face, one eye, or two eyes, one monitoring image capturing the driver Ob with the face oriented closest to the front. For example, when finding one monitoring image containing the two eyes of the driver Ob, the image selection unit 1111 simply selects the image. When finding multiple monitoring images containing the two eyes of the driver Ob, the image selection unit 1111 selects, from the monitoring images, one monitoring image capturing the driver Ob with the face oriented closest to the front. When finding no monitoring image containing the two eyes of the driver Ob and finding one monitoring image containing one eye of the driver Ob, the image selection unit 1111 simply selects, from the monitoring images, the image containing one eye of the driver Ob. When finding multiple monitoring images containing one eye of the driver Ob, the image selection unit 1111 selects, from these multiple monitoring images, one monitoring image capturing the driver Ob with the face oriented closest to the front. When finding no monitoring image containing one or both eyes of the driver Ob, the image selection unit 1111 selects, from the monitoring images containing no eye, one monitoring image capturing the driver Ob with the face oriented closest to the front.

The state estimation unit 1112 estimate the state of the driver Ob, including a drowsy state and a distracted state of the driver Ob with a known method based on the monitoring image selected by the image selection unit 1111.

The image selection unit 1111 may select multiple monitoring images, rather than one monitoring image. For example, the image selection unit 1111 may select all the monitoring images each containing the two eyes of the driver Ob. In this case, the state estimation unit 1112 estimates the state of the driver Ob based on each monitoring image selected by the image selection unit 1111, and provides the average of the resultant estimates as an estimation result for the state of the driver Ob. When finding no monitoring image containing the two eyes of the driver Ob, the image selection unit 1111 may select all the monitoring images each containing one eye of the driver Ob. In this case, the state estimation unit 1112 estimates the state of the driver Ob based on each of the monitoring images selected by the image selection unit 1111, and provides the average of the resultant estimates as an estimation result for the state of the driver Ob. When the number of selected monitoring images each containing one eye of the driver Ob is less than a predetermined number, the image selection unit 1111 may further select, from the monitoring images containing no eye of the driver Ob, one or more monitoring images in order from a monitoring image capturing the driver Ob with the face oriented closer to the front to add up to the predetermined number. The predetermined number is an integer greater than or equal to two and smaller than the number (N) of cameras 2-1, 2-2, . . . , and 2-N. The state estimation unit 1112 estimates the state of the driver Ob based on each of the monitoring images selected by the image selection unit 1111 and provides the average of the resultant estimates as the estimation result for the state of the driver Ob. When the number of selected monitoring images each containing one eye of the driver Ob is less than the predetermined number, the image selection unit 1111 may further select, from the monitoring images containing no eye of the driver Ob, one or more monitoring images in order from a monitoring image capturing the target person with the face oriented closer to the front to add up to the predetermined number.

The estimation state output unit 1113 outputs state estimation result information indicating the state estimation result estimated by the state estimation unit 1112. The estimation state output unit 1113 includes, for example, a speaker and an alert indicator lamp to output the state estimation result information to the driver appropriately by emitting an alert sound or lighting the alert lamp, depending on the state estimation result from the state estimation unit 1112. The estimation state output unit 1113 may be one of the speaker and the alert indicator lamp. The alert sound and the alert indication may be implemented by a sound output function and an image display function of a navigation system included in the vehicle. In this case, the estimation state output unit 1113 may output the state estimation result information to an external device, such as a navigation system.

Instead of outputting the state estimation result information to the driver Ob, the estimation state output unit 1113 may output the state estimation result information to an external device such as an automatic driving device installed in the vehicle or to an automatic driving controlling device that controls the automatic driving device. The external device then operates in accordance with the state estimation result information. For example, the automatic driving controlling device can determine whether the driving mode is switchable from an automatic driving mode performed by the automatic driving device to a manual driving mode performed by the driver Ob in accordance with the state estimation result information.

When the target person is a driver or an operator of machinery used in manufacturing facilities or plants, the estimation state output unit 1113 may output, in addition to or instead of outputting the information to the driver or the operator, the state estimation result information through wireless or wired communication to a terminal operated by a manager who supervises the driver or the operator or to an alert device installed in the management department.

In the state estimation apparatus 1 with the above structure, multiple cameras 2-1, 2-2, . . . , and 2-N are installed to capture images of a target person, for example the vehicle driver Ob, from different positions, and the image selection unit 1111 selects at least one monitoring image used for the state estimation from multiple monitoring images of the driver Ob captured by the cameras 2-1, 2-2, . . . , and 2-N. The state estimation unit 1112 then estimates the state of the driver Ob based on the selected monitoring image, and the estimation state output unit 1113 outputs the state estimation result information indicating the estimation result for the state of the driver Ob. Although a monitoring image of the driver Ob captured by one camera, for example the camera 2-1, cannot be used for the state estimation, the state of the driver Ob may be estimated based on a monitoring image captured by another camera, for example, the camera 2-2. The state estimation apparatus 1 can thus estimate the state of the driver Ob in any conditions in a stable manner.

In the state estimation apparatus 1, the image selection unit 1111 selects a monitoring image containing the face of the driver Ob from the monitoring images, and the state estimation unit 1112 estimates the state of the driver Ob based on the selected one monitoring image. The state estimation apparatus 1 thus estimates the state of the driver Ob in any conditions based on the selected monitoring image containing the face of the driver Ob.

In the state estimation apparatus 1, the image selection unit 1111 may select a monitoring image containing an eye of the driver Ob from the monitoring images, and the state estimation unit 1112 estimates the state of the driver Ob based on the selected one monitoring image. The eyes of the driver Ob are featuring information to be used in estimating the state of the driver Ob. The state estimation unit 1112 can thus estimate the state of the driver Ob in a stable manner based on the selected monitoring image containing an eye of the driver Ob.

In the state estimation apparatus 1, the image selection unit 1111 may specifically selects a monitoring image containing the two eyes of the driver Ob from the monitoring images, and the state estimation unit 1112 estimates the state of the driver Ob based on the selected one monitoring image. The state estimation unit 1112 thus obtains a reliable estimation result for the state of the driver Ob.

In the state estimation apparatus 1, the image selection unit 1111 selects, from multiple selected monitoring images, one monitoring image capturing the driver Ob with the face oriented closest to the front. The state estimation unit 1112 thus easily estimates the state of the driver Ob based on the monitoring image containing the face of the driver Ob oriented in the forward direction. The state estimation apparatus 1 thus obtains a highly reliable estimation result.

In the state estimation apparatus 1, the image selection unit 1111 selects one monitoring image capturing the driver Ob with the face oriented closest to the front from the monitoring images each containing the two eyes of the driver Ob, and the state estimation unit 1112 estimates the state of the driver Ob based on the selected one monitoring image. The state estimation apparatus 1 thus estimates the state of the driver Ob based on the monitoring image containing the two eyes of the driver Ob, which is most appropriate for the state estimation. The state estimation apparatus 1 thus obtains a highly reliable estimation result.

In the state estimation apparatus 1, when finding no monitoring image containing the two eyes of the driver Ob, the image selection unit 1111 selects one monitoring image capturing the driver Ob with the face oriented closest to the front from the monitoring images each containing one eye of the driver Ob, and the state estimation unit 1112 estimates the state of the driver Ob based on the selected one monitoring image. The state estimation apparatus 1 thus obtains a reliable estimation result based on the monitoring image most appropriate for the state estimation selected from the monitoring images each containing one eye of the driver Ob.

In the state estimation apparatus 1, when finding no monitoring image containing one or both eyes of the driver Ob, the image selection unit 1111 selects one monitoring image capturing the driver Ob with the face oriented closest to the front from the monitoring images each containing no eye, and the state estimation unit 1112 estimates the state of the driver Ob based on the selected one monitoring image. The state estimation apparatus 1 thus obtains a fairly reliable estimation result based on the monitoring image most appropriate for the state estimation using the facial expression of the driver Ob selected from monitoring images including no eye of the driver Ob.

In the state estimation apparatus 1, the image selection unit 1111 selects all the monitoring images each containing the two eyes of the driver Ob, and the state estimation unit 1112 estimates the target state based on each monitoring image containing the two eyes of the driver Ob to provide the average of the resultant estimates as an estimation result for the state of the driver Ob. The state estimation apparatus 1 thus obtains a highly reliable final estimation result.

In the state estimation apparatus 1, when finding no monitoring image containing the two eyes of the driver Ob, the image selection unit 1111 selects all the monitoring images each containing one eye of the driver Ob, and the state estimation unit 1112 estimates the target state based on each monitoring image containing one eye of the driver Ob to provide the average of the resultant estimates as an estimation result for the state of the driver Ob. The state estimation apparatus 1 thus obtains a more reliable estimation result than an estimation result obtained based on one monitoring image containing one eye of the driver Ob.

In this case, when the number of selected monitoring images is less than a predetermined number, or in other words when the number of monitoring images each containing one eye of the driver Ob is less than intended, the image selection unit 1111 further selects one or more monitoring images capturing the driver Ob with the face oriented closer to the front and uses the selected images in the state estimation performed by the state estimation unit 1112. The state estimation apparatus 1 thus obtains a more reliable estimation result than an estimation result based on one monitoring image containing one eye of the driver Ob.

In the state estimation apparatus 1, when finding no monitoring image containing one or both eyes of the driver Ob, the image selection unit 1111 selects, from the monitoring images each containing no eye, a predetermined number of monitoring images in order from a monitoring image capturing the driver Ob with the face oriented closer to the front, and uses the selected images in the state estimation performed by the state estimation unit 1112. The state estimation apparatus 1 thus obtains a fairly reliable estimation result based on the predetermined number of monitoring images selected from the monitoring images containing no eye of the driver Ob and appropriate for the state estimation using the facial expression of the driver Ob.

### First Embodiment

A first embodiment of the present invention will now be described. In the present embodiment, the drowsiness of a vehicle driver Ob is estimated.

### Structure

### 1. System

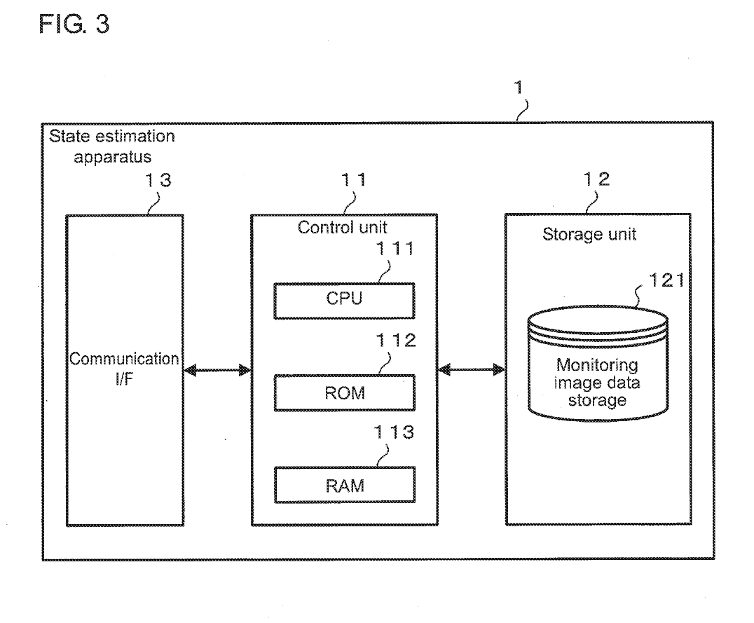

FIG. 3 is a block diagram of a state estimation apparatus according to the first embodiment of the invention showing its hardware configuration.

The state estimation apparatus 1 includes a control unit 11, which is a hardware processor, a storage unit 12, and a communication interface 13, which are electrically connected to one another. In FIG. 3, the communication interface is abbreviated as the communication I/F.

The control unit 11 controls the operation of each unit in the state estimation apparatus 1. The control unit 11 includes a central processing unit (CPU) 111, a read only memory (ROM) 112, and a random access memory (RAM) 113. The CPU 111 is an example of a hardware processor. The CPU 111 expands, into the RAM 113, the state estimation program stored in the ROM 112 or the storage unit 12. The CPU 111 then interprets and executes the state estimation program in the RAM 113. This allows the control unit 11 to implement the function of each unit in the software configuration described later. Although the state estimation program is prestored in the ROM 112 or the storage unit 12, the state estimation program may be downloaded to the state estimation apparatus 1 through a network such as the Internet or a local area network (LAN), and stored in the storage unit 12. The state estimation program may be stored in a non-transitory computer-readable medium, such as a ROM, and distributed.

The communication interface 13 connects each of the multiple cameras 2-1, 2-2, . . . , and 2-N to the control unit 11. The communication interface 13 may include an interface for wired communication or an interface for wireless communication. The communication interface 13 may include an interface for communication through a network to download the state estimation program stored in the storage unit 12.

The storage unit 12 is an auxiliary storage. The storage unit 12 includes a storage medium including, but not limited to, a hard disk drive (HDD) or a solid state drive (SSD), which is writable and readable as appropriate. The storage area of the storage unit 12 may include a data storage unit for storing a variety of data items in addition to a program storage unit for storing the state estimation program executed by the control unit 11. The data storage unit may include a monitoring image data storage 121 that stores, for example, multiple monitoring image data pieces obtained by the control unit 11 from the cameras 2-1, 2-2, . . . , and 2-N via the communication interface 13. Each monitoring image data piece contains at least the face of the driver Ob, which is a target person, captured from a different position.

For the specific hardware configuration of the state estimation apparatus 1, components may be eliminated, substituted, or added as appropriate. For example, the control unit 11 may include multiple hardware processors.

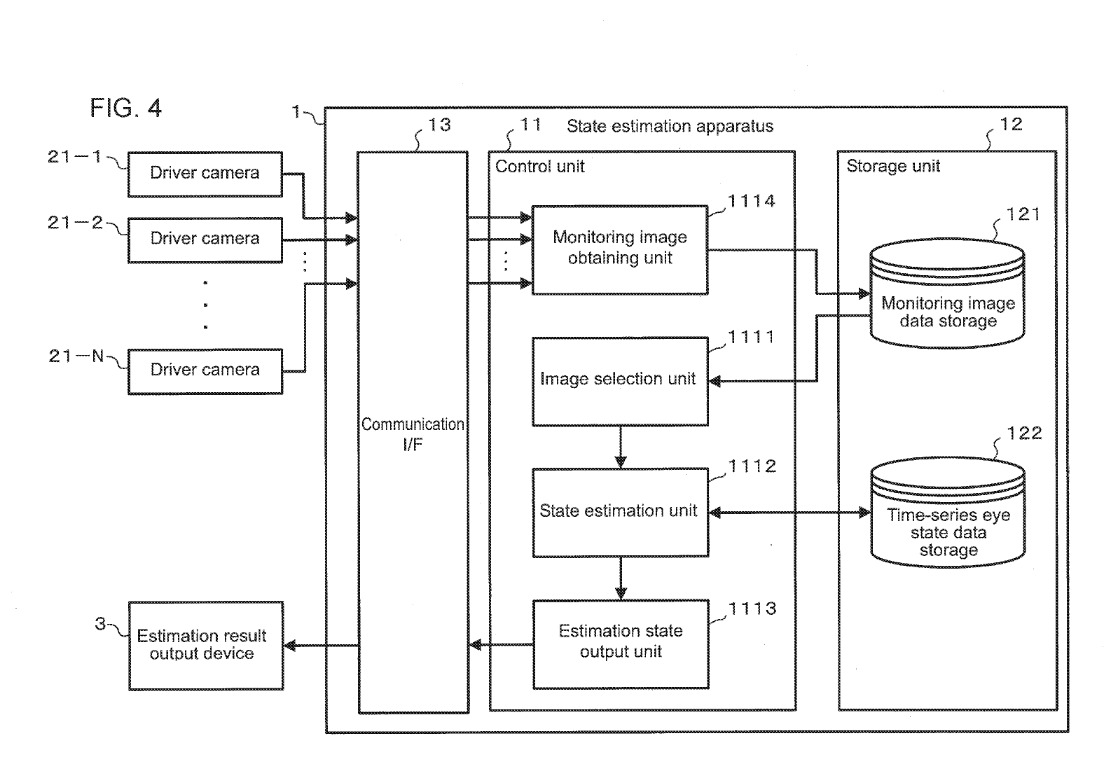

FIG. 4 is a block diagram of a state estimation system including the state estimation apparatus 1, showing its software configuration in addition to the hardware configuration shown in FIG. 3.

The state estimation system includes the state estimation apparatus 1, the driver cameras 21-1, 21-2, . . . , and 21-N connected to the state estimation apparatus 1, and an estimation result output device 3 connected to the state estimation apparatus 1.

The state estimation apparatus 1 includes the control unit 11, the storage unit 12, and the communication interface 13. The control unit 11 includes, as a software processing unit, the image selection unit 1111, the state estimation unit 1112, the estimation state output unit 1113, and a monitoring image obtaining unit 1114. Each of these software units may be a dedicated hardware unit. The data storage unit in the storage area of the storage unit 12 includes a monitoring image data storage 121 and a time-series eye state data storage 122.

### 2. Driver Cameras

The driver cameras 21-1, 21-2, . . . , and 21-N are installed to capture images of the face of the vehicle driver Ob, which is a target person, from different positions to obtain monitoring images of the driver Ob. These driver cameras 21-1, 21-2, . . . , and 21-N may each be installed, for example, on the dashboard, at the center of the steering wheel, beside the speed meter, or on a front pillar. The driver cameras 21-1, 21-2, . . . , and 21-N may be still cameras or video cameras. The still cameras capture multiple still images of the driver Ob per second.

### 3. State Estimation Apparatus

The communication interface 13 receives image signals output from the driver cameras 21-1, 21-2, . . . , and 21-N, converts the signals into digital data, and inputs the data to the control unit 11. The communication interface 13 further converts the state estimation result information output from the control unit 11 into output control signals, and outputs the signals to the estimation result output device 3.

The monitoring image data storage 121 in the storage unit 12 stores multiple monitoring image data pieces about the driver Ob captured by the driver cameras 21-1, 21-2, . . . , and 21-N. The time-series eye state data storage 122 in the storage unit 12 stores, as time-series data, the eye opening/closing states of the right and left eyes of the driver Ob measured using the monitoring image data.

The monitoring image obtaining unit 1114 in the control unit 11 obtains monitoring images of the driver Ob from the driver cameras 21-1, 21-2, . . . , and 21-N. More specifically, the monitoring image obtaining unit 1114 obtains sensing data, which is digital data about the image signals of the driver Ob output from the driver cameras 21-1, 21-2, . . . , and 21-N, from the communication interface 13 at a predetermined sampling rate, and stores the obtained sensing data into the monitoring image data storage 121 in the storage unit 12 as monitoring image data about the driver Ob.

The image selection unit 1111 in the control unit 11 selects one monitoring image data piece for drowsiness estimation from multiple monitoring image data pieces about the driver Ob captured by the driver cameras 21-1, 21-2, . . . , and 21-N and stored in the monitoring image data storage 121. The operation for selecting one monitoring image data piece by the image selection unit 1111 will be described in detail later.

The state estimation unit 1112 in the control unit 11 measures, for example, the eye opening/closing states of the right and left eyes of the driver Ob based on the one monitoring image data piece selected by the image selection unit 1111, and estimates the drowsiness of the driver Ob using the measurement results and the time-series eye opening/closing data for the right and left eyes of the driver Ob stored in the time-series eye state data storage 122. The drowsiness estimation by the state estimation unit 1112 will be described in detail later.

The estimation state output unit 1113 in the control unit 11 outputs the state estimation result information indicating the estimation result for the state estimation unit 1112 about the drowsiness of the driver Ob to the estimation result output device 3 via the communication interface 13.

### 4. Estimation Result Output Device

The estimation result output device 3 includes, for example, a speaker and an alert indicator lamp to output the state estimation result information output from the state estimation apparatus 1 to the driver Ob by emitting an alert sound or lighting the alert lamp. The estimation result output device 3 may be one of the speaker and the alert indicator lamp. The estimation result output device 3 may be implemented by a sound output function and an image display function of a navigation system included in the vehicle. The estimation result output device 3 may be included in the state estimation apparatus 1 as the estimation state output unit 1113.

### Operation

The operation of the state estimation system with the above structure will now be described.

### 1. Sensing Data Obtaining

When the vehicle power system is turned on, the state estimation apparatus 1, the driver cameras 21-1, 21-2, . . . , and 21-N serving as driver monitor sensors, and the estimation result output device 3 start operating. The state estimation apparatus 1 obtains sensing data from the driver cameras 21-1, 21-2, . . . , and 21-N through the monitoring image obtaining unit 1114, and stores the data into the monitoring image data storage 121 as the monitoring image data. The monitoring image data is obtained and stored repeatedly until the vehicle power system is turned off.

### 2. Drowsiness Estimation

### 2-1. Selection of Monitoring Image

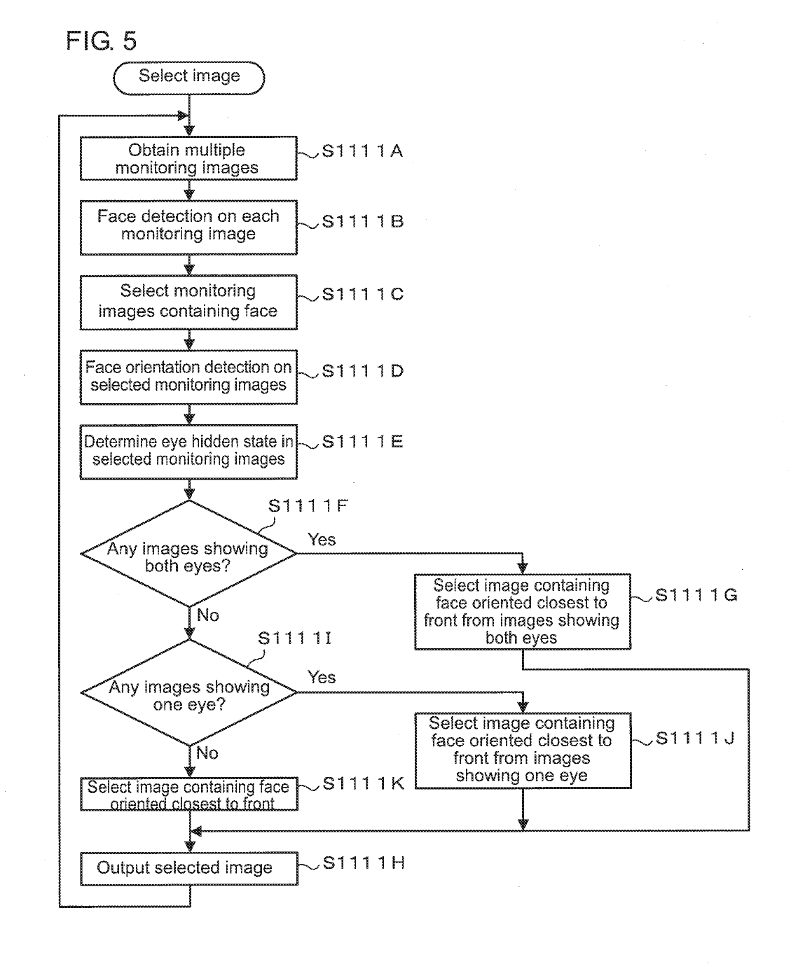

FIG. 5 is a flowchart showing the procedure and the processing performed by the image selection unit 1111 in the state estimation apparatus 1 shown in FIG. 4.

The image selection unit 1111 obtains monitoring image data pieces captured by the driver cameras 21-1, 21-2, . . . , and 21-N from the monitoring image data storage 121 in step S1111A at timing in accordance with the predetermined sampling rate at which the monitoring image obtaining unit 1114 obtains monitoring image data. In step S1111B, the image selection unit 1111 then performs face detection using each of the obtained monitoring image data pieces with a known method to detect the face of the driver Ob in the monitoring image data. In step S1111C, the image selection unit 1111 selects the monitoring image data pieces containing the face.

The image selection unit 1111 thus first selects the monitoring image data pieces containing the face.

In step S1111D, the image selection unit 1111 performs face orientation detection using each monitoring image data piece selected in step S1111C with a known method based on the features including the eyes, nose, and mouth. The image selection unit 1111 detects the orientation of the face of the driver Ob in each selected monitoring image data piece. The face orientation herein refers to the orientation of the face with respect to the front of the driver camera that has captured the monitoring image data piece, and does not refer to the orientation of the face with respect to the front of the vehicle. The apparatus according to the present embodiment does not use the orientation of the face with respect to the front of the vehicle for drowsiness estimation. The apparatus may use the face orientation with respect to the front of the vehicle for other state estimation, such as distracted driving estimation. For such estimation, the face orientation with respect to the front of the vehicle can be easily calculated based on the face orientation with respect to each of the driver cameras 21-1, 21-2, . . . , and 21-N installed at known angles with respect to the front of the vehicle.

In step S1111E, the image selection unit 1111 determines the hidden state of the eyes of the driver Ob for each monitoring image data piece selected in step S1111C. More specifically, the image selection unit 1111 determines whether each monitoring image data piece shows two eyes, one eye, or no eye. The operations in steps S1111D and S1111E may be performed in the opposite order or in parallel.

In step S1111F, the image selection unit 1111 determines whether any of the monitoring image data pieces selected in step S1111C shows the two eyes of the driver Ob. This determination may be performed based on the result of determination in step S1111E about the hidden eye state of the driver Ob.

When determining that any of the monitoring image data pieces shows the two eyes of the driver Ob in step S1111F, the image selection unit 1111 selects, in step S1111G, a monitoring image data piece capturing the driver Ob with the face oriented closest to the front from the monitoring image data pieces showing the two eyes of the driver Ob. This selection may be performed based on the results of the face orientation detection in step S1111D. In step S1111H, the image selection unit 1111 outputs the selected one monitoring image data piece to the state estimation unit 1112 as the monitoring image data to be used for the drowsiness estimation performed by the state estimation unit 1112. The image selection unit 1111 returns to step S1111A.

In this manner, the image selection unit 1111 selects one monitoring image data piece capturing the driver Ob with the face oriented closest to the front from the monitoring image data pieces captured by the driver cameras 21-1, 21-2, . . . , and 21-N and containing the two eyes of the driver Ob, and outputs the selected data piece to the state estimation unit 1112. When only one monitoring image data piece contains the two eyes of the driver Ob, the image selection unit 1111 simply selects the image, and outputs the image to the state estimation unit 1112.

When determining that no monitoring image data piece shows the two eyes of the driver Ob in step S1111F, the image selection unit 1111 determines, in step S1111I, whether any of the monitoring image data pieces shows one eye of the driver Ob based on the monitoring image data pieces selected in step S1111C.

When determining that any of the monitoring image data shows one eye of the driver Ob in step S1111I, the image selection unit 1111 selects, in step S1111J, an image capturing the driver Ob with the face oriented closest to the front from the monitoring image data pieces showing one eye of the driver Ob. This selection may be performed based on the face orientation detection result in step S1111D. The image selection unit 1111 then outputs, in step S1111H, the selected one monitoring image data piece to the state estimation unit 1112 as the monitoring image data to be used for the drowsiness estimation performed by the state estimation unit 1112. When the image selection unit 1111 selects and outputs the monitoring image data piece showing one eye of the driver Ob, the image selection unit 1111 may also output information indicating whether the left or right eye is shown. The image selection unit 1111 then returns to step S1111A.

In this manner, when determining that none of the monitoring image data pieces captured by the driver cameras 21-1, 21-2, . . . , and 21-N shows the two eyes of the driver Ob and finding one or more data pieces showing one eye of the driver Ob, the image selection unit 1111 selects one monitoring image data piece capturing the driver Ob with the face oriented closest to the front from these monitoring image data pieces showing one eye of the driver Ob. The image selection unit 1111 then outputs the selected data piece to the state estimation unit 1112. When finding one monitoring image data piece showing one eye of the driver Ob, the image selection unit 1111 simply selects the image, and outputs the image to the state estimation unit 1112.

When finding no monitoring image data showing one eye of the driver Ob in step S1111I, the image selection unit 1111 selects, in step S1111K, one image capturing the driver Ob with the face oriented closest to the front from the monitoring image data pieces captured by the driver cameras 21-1, 21-2, . . . , and 21-N. This selection may be performed based on the face orientation detection result in step S1111D. In step S1111H, the image selection unit 1111 then outputs the selected one monitoring image data piece to the state estimation unit 1112 as the monitoring image data to be used for the drowsiness estimation performed by the state estimation unit 1112. The image selection unit 1111 then returns to step S1111A.

In this manner, when finding no monitoring image data piece captured by the driver cameras 21-1, 21-2, . . . , and 21-N showing one or both eyes of the driver Ob, the image selection unit 1111 selects one monitoring image data piece capturing the driver Ob with the face oriented closest to the front from all the obtained monitoring image data pieces, and outputs the selected image to the state estimation unit 1112.

The image selection unit 1111 thus repeatedly selects one monitoring image data piece for the state estimation unit 1112 from the monitoring image data pieces stored in the monitoring image data storage 121 until the vehicle power system is turned off.

### 2-2. Drowsiness Estimation

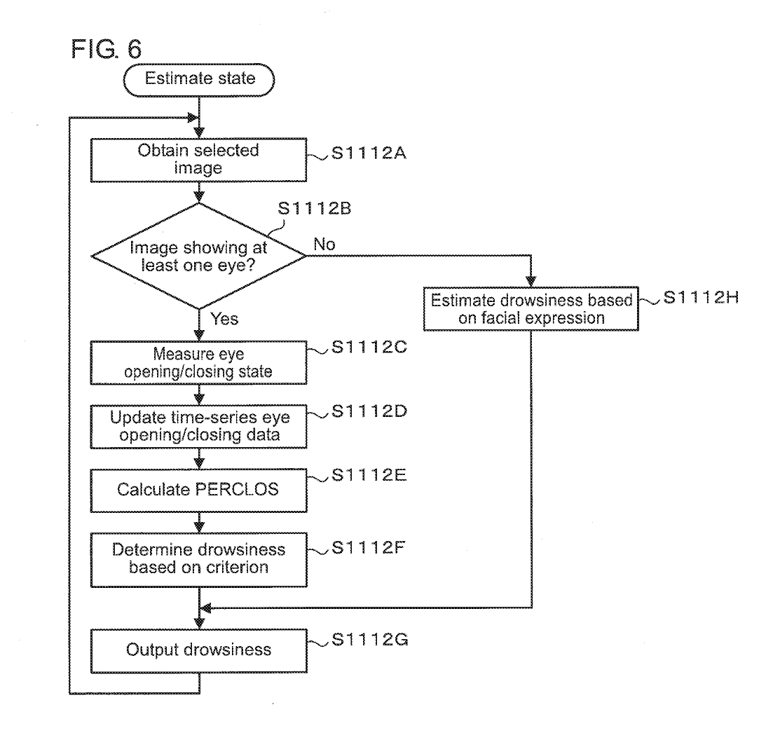

FIG. 6 is a flowchart showing the procedure and the processing performed by the state estimation unit 1112 in the state estimation apparatus 1 shown in FIG. 4.

In step S1112A, the state estimation unit 1112 first obtains the monitoring image data piece selected by the image selection unit 1111. In the present embodiment, the image selection unit 1111 outputs the selected monitoring image data to the state estimation unit 1112. In some embodiments, the image selection unit 1111 may simply output information specifying the selected monitoring image data piece such as a file name, selectively from the monitoring image data pieces stored in the monitoring image data storage 121. In this case, the state estimation unit 1112 reads and obtains the corresponding monitoring image data piece from the monitoring image data storage 121 based on the information. In some embodiments, the image selection unit 1111 may output data in step S1111H by removing the monitoring image data pieces except the selected data piece from the RAM 113, into which the monitoring image data pieces are to be input in step S1111A. In this case, the state estimation unit 1112 may process the monitoring image data piece remaining in the RAM 113. This eliminates step S1112A.

In step S1112B, the state estimation unit 1112 determines whether the obtained monitoring image data piece shows at least one eye of the driver Ob.

When determining that the obtained monitoring image data piece shows at least one eye of the driver Ob in step S1112B, the state estimation unit 1112 measures the opening or closing state of one or two eyes of the driver Ob included in the obtained monitoring image data piece in step S1112C. In step S1112D, the state estimation unit 1112 updates the time-series eye opening/closing data for the right and left eyes of the driver Ob stored in the time-series eye state data storage 122 in the storage unit 12 with the determination result in step S1112C. In step S1112E, the state estimation unit 1112 calculates the percentage of eyelid closure over the pupil over time (PERCLOS) based on the time-series eye opening/closing data stored in the time-series eye state data storage 122. PERCLOS is the rate (%) of time the eyes are closed for the last one minute, or an index for measuring the driver fatigue level authorized by the National Highway Traffic Safety Administration of the U.S. government. In step S1112F, the state estimation unit 1112 determines the drowsiness of the driver Ob by comparing the calculated PERCLOS with a predetermined criterion. In step S1112G, the state estimation unit 1112 outputs the determined drowsiness to the estimation state output unit 1113 as a state estimation result. The state estimation unit 1112 then returns to step S1112A.

In contrast, when determining that the obtained monitoring image data piece shows no eye of the driver Ob in step S1112B, the state estimation unit 1112 estimates, in step S1112H, the drowsiness of the driver Ob based on the facial expression of the driver Ob from the obtained monitoring image data piece. For example, the state estimation unit 1112 estimates whether the driver Ob is yawning based on the opening/closing state of the mouth. In step S1112G, the state estimation unit 1112 outputs the estimated drowsiness to the estimation state output unit 1113. The state estimation unit 1112 then returns to step S1112A.

The state estimation unit 1112 thus repeatedly determines or estimates the drowsiness of the driver Ob based on the one monitoring image selected by the image selection unit 1111 until the vehicle power system is turned off.

### 2-3. Drowsiness Output

The estimation state output unit 1113 determines whether the driver Ob is to be alerted based on the drowsiness determined or estimated by the state estimation unit 1112. The estimation state output unit 1113 outputs the state estimation result information indicating the estimated drowsiness of the driver Ob to the estimation result output device 3 as appropriate. The estimation result output device 3 thus provides the state estimation result information to the driver Ob by emitting an alert sound or lighting the alert lamp.

### Effects of First Embodiment

In the state estimation apparatus 1 according to the embodiment described above, the image selection unit 1111 selects one monitoring image data piece for the drowsiness estimation from multiple monitoring image data pieces about the vehicle driver Ob, which is a target person, captured by the driver cameras 21-1, 21-2, . . . , and 21-N installed at different positions and stored in the monitoring image data storage 121 in the storage unit 12. The state estimation unit 1112 estimates the drowsiness of the driver Ob based on the selected one monitoring image data piece. The estimation state output unit 1113 outputs the state estimation result information indicating the estimated drowsiness of the driver Ob from the estimation result output device 3 to the driver Ob.

More specifically, the driver cameras 21-1, 21-2, . . . , and 21-N are installed to capture images of the driver Ob from different positions, and the image selection unit 1111 selects one monitoring image data piece for the drowsiness estimation from the monitoring image data pieces about the driver Ob captured by these driver cameras 21-1, 21-2, . . . , and 21-N. The state estimation unit 1112 then estimates the drowsiness of the driver Ob based on the selected monitoring image data piece, and the estimation state output unit 1113 outputs the state estimation result information indicating the estimation result to the estimation result output device 3. Although a monitoring image data piece about the driver Ob captured by one driver camera may not be used for the drowsiness estimation, a monitoring image data piece captured by another driver camera may be used for estimating the drowsiness of the driver Ob. The state estimation apparatus 1 can thus estimate the drowsiness of the driver Ob in any conditions in a stable manner. The state estimation apparatus 1 obtains a monitoring image data piece capturing the driver Ob with the face oriented close to the front when, for example, the driver Ob is looking to a side mirror or looking aside or obliquely back. The monitoring image data piece can be used to accurately estimate the drowsiness of the driver Ob. In addition, the face of the driver Ob may be temporarily hidden due to an action of the driver Ob, such as operating the steering wheel Ha or scratching the face, and may not be captured by one driver camera. In this case, the state estimation apparatus 1 uses a monitoring image data piece captured by another driver camera to continuously estimate the drowsiness of the driver Ob.

In the state estimation apparatus 1, the image selection unit 1111 selects a monitoring image data piece containing the face of the driver Ob from the monitoring image data pieces.

In this manner, the state estimation apparatus 1 uses the monitoring image data piece containing the face of the driver Ob selected from the monitoring image data pieces to estimate the drowsiness of the driver Ob. The state estimation apparatus 1 thus estimates the drowsiness of the driver Ob in any conditions based on a selected monitoring image data piece containing the face of the driver Ob.

In the state estimation apparatus 1, the image selection unit 1111 may select a monitoring image data piece containing an eye of the driver Ob from the monitoring image data pieces.

In this manner, the state estimation apparatus 1 uses a monitoring image data piece containing an eye of the driver Ob selected from the monitoring image data pieces to estimate the drowsiness of the driver Ob. An eye of the driver Ob is featuring information to be used in estimating the drowsiness of the driver Ob. The state estimation apparatus 1 can thus estimate the drowsiness of the driver Ob in a stable manner based on a selected image data piece containing an eye of the driver Ob.

In the state estimation apparatus 1, the image selection unit 1111 may select a monitoring image data piece containing the two eyes of the driver Ob from the monitoring image data pieces.

In this manner, the state estimation apparatus 1 uses a monitoring image data piece containing the two eyes of the driver Ob selected from the monitoring image data pieces to estimate the drowsiness of the driver Ob. The state estimation apparatus 1 thus obtains a reliable estimation result about the drowsiness of the driver Ob.

In the state estimation apparatus 1, the image selection unit 1111 selects one monitoring image data piece capturing the driver Ob with the face oriented closest to the front from multiple selected monitoring image data pieces.

In this manner, the state estimation apparatus 1 uses one monitoring image data piece capturing the driver Ob with the face oriented closest to the front selected from the selected monitoring image data pieces. The state estimation apparatus 1 can thus easily estimate the drowsiness based on a monitoring image data piece capturing the face of the driver Ob oriented in the forward direction, and obtain a highly reliable estimation result.

In the state estimation apparatus 1, the image selection unit 1111 selects one monitoring image data piece capturing the driver Ob with the face oriented closest to the front from monitoring image data pieces each containing the two eyes of the driver Ob.

In this manner, the state estimation apparatus 1 uses one monitoring image data piece capturing the driver Ob with the face oriented closest to the front selected from the monitoring image data pieces each containing the two eyes of the driver Ob to estimate the drowsiness of the driver Ob. The state estimation apparatus 1 can thus estimate the drowsiness based on the monitoring image data piece most appropriate for the estimation, and obtain a highly reliable drowsiness estimation result.

In the state estimation apparatus 1, when finding no monitoring image containing the two eyes of the driver Ob, the image selection unit 1111 selects one monitoring image data piece capturing the driver Ob with the face oriented closest to the front from monitoring image data pieces each containing one eye of the driver Ob.

In this manner, when finding no monitoring image data piece showing the two eyes of the driver Ob, the state estimation apparatus 1 uses one monitoring image data piece capturing the driver Ob with the face oriented closest to the front selected from the monitoring image data pieces each containing one eye of the driver Ob to estimate the drowsiness of the driver Ob. The state estimation apparatus 1 thus obtains a reliable drowsiness estimation result based on the monitoring image most appropriate for the drowsiness estimation selected from the monitoring image data pieces each containing one eye of the driver Ob.

In the state estimation apparatus 1, when finding no monitoring image containing one or both eyes of the driver Ob, the image selection unit 1111 selects one monitoring image data piece capturing the driver Ob with the face oriented closest to the front from monitoring image data pieces each containing no eye.

In this manner, when finding no monitoring image containing one or both eyes of the driver Ob, the state estimation apparatus 1 uses one monitoring image data piece capturing the driver Ob with the face oriented closest to the front selected from the monitoring image data pieces to estimate the drowsiness of the driver Ob. The state estimation apparatus 1 thus obtains a fairly reliable drowsiness estimation result based on the monitoring image most appropriate for the drowsiness estimation using the facial expression of the driver Ob selected from the monitoring image data pieces containing no eye of the driver Ob.

### Second Embodiment

A second embodiment of the present invention will now be described. As in the first embodiment, the drowsiness of a vehicle driver Ob is estimated in the second embodiment. For ease of explanation, the second embodiment will be described focusing on its differences from the first embodiment, and will not be described repeatedly.

### Configuration

### 1. System

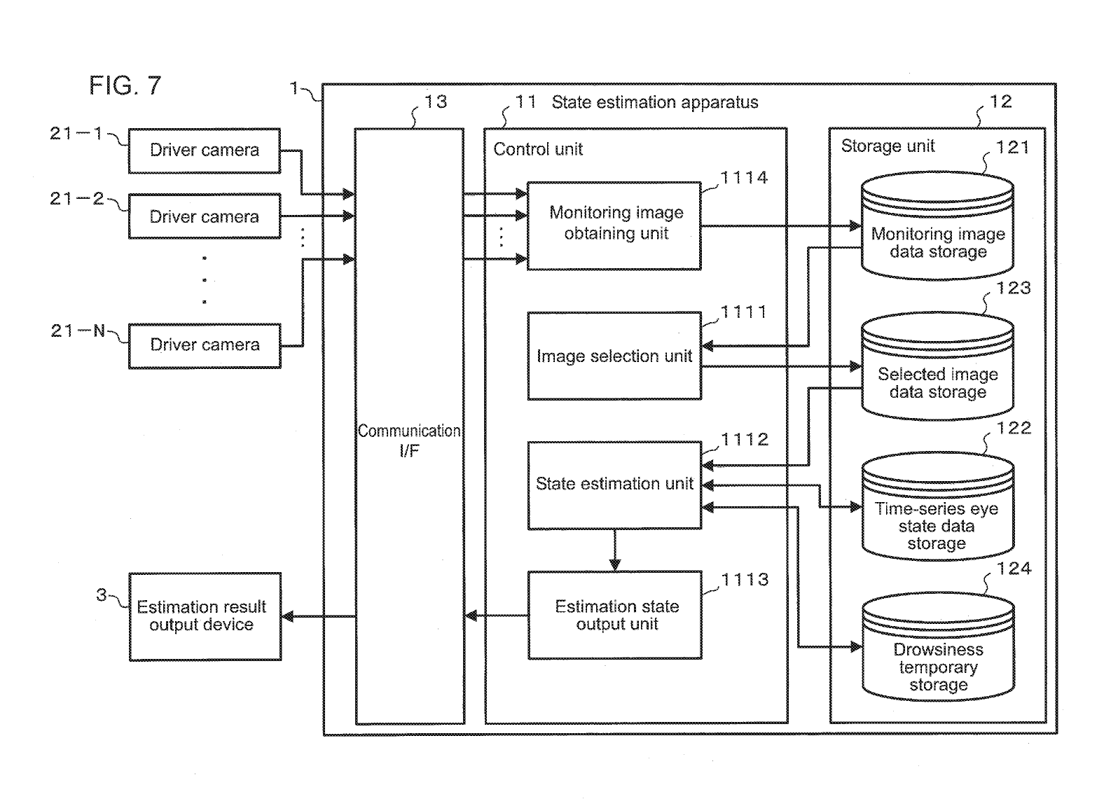

FIG. 7 is a block diagram of a state estimation system including a state estimation apparatus 1 according to a second embodiment of the invention showing its software configuration.

The state estimation system includes a state estimation apparatus 1 according to the second embodiment of the invention, and multiple driver cameras 21-1, 21-2, . . . , and 21-N and an estimation result output device 3, which are connected to the state estimation apparatus 1. The state estimation apparatus 1 further includes, in addition to the same components as in the first embodiment, a selected image data storage 123 and a drowsiness temporary storage 124 in the data storage unit included in the storage area of the storage unit 12.

### 2. State Estimation Apparatus

The selected image data storage 123 in the storage unit 12 stores a monitoring image data piece selected by the image selection unit 1111 in the control unit 11 as a selected image data piece. The drowsiness temporary storage 124 in the storage unit 12 temporarily stores the drowsiness estimated by the state estimation unit 1112 for each selected image data piece. In the second embodiment, the time-series eye state data storage 122 temporarily stores information about the eye opening/closing state measured by the state estimation unit 1112 using each selected image data piece, in addition to the time-series eye opening/closing data about the driver Ob.

The image selection unit 1111 in the control unit 11 selects multiple monitoring image data pieces for the drowsiness estimation from multiple monitoring image data pieces about the driver Ob obtained by the driver cameras 21-1, 21-2, . . . , and 21-N and stored in the monitoring image data storage 121. Whereas the image selection unit 1111 selects one monitoring image data piece in the first embodiment, the image selection unit 1111 selects multiple monitoring image data pieces in the second embodiment. The image selection unit 1111 stores the selected monitoring image data pieces as the selected image data pieces into the selected image data storage 123. The selection of such multiple monitoring image data pieces by the image selection unit 1111 will be described in detail later.

The state estimation unit 1112 in the control unit 11 measures, for example, the eye opening/closing state of the driver Ob based on each of the selected image data pieces stored in the selected image data storage 123, and temporarily stores the measurement results in the time-series eye state data storage 122. The state estimation unit 1112 estimates the drowsiness of the driver Ob using the time-series eye opening/closing data about the driver Ob stored in the time-series eye state data storage 122 and the temporarily stored eye opening/closing state for each selected image data piece. The state estimation unit 1112 then stores the measurement results in the drowsiness temporary storage 124. The state estimation unit 1112 calculates a final drowsiness estimation result using the drowsiness based on each of the selected image data pieces stored in the drowsiness temporary storage 124, and outputs the result to the estimation state output unit 1113. The drowsiness estimation by the state estimation unit 1112 will be described in detail later.

### Operation

The operation of the state estimation system with the above structure will now be described.

The sensing data is obtained in the same manner as in the first embodiment.

The drowsiness is estimated in the manner described below.

### 1. Selecting Monitoring Image Data

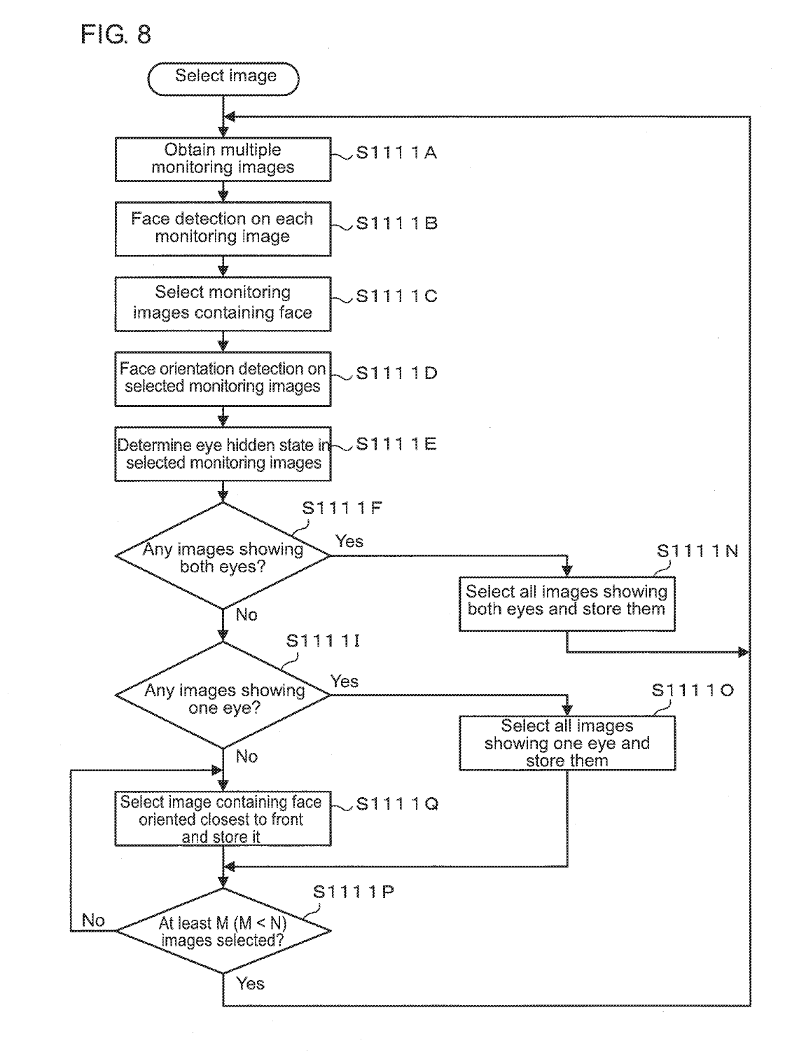

FIG. 8 is a flowchart showing the procedure and operation performed by the image selection unit 1111 in the state estimation apparatus 1 shown in FIG. 7.

After the processing in steps S1111A to S1111E as in the first embodiment, the image selection unit 1111 determines, in step S1111F, whether any of the selected monitoring image data pieces shows the two eyes of the driver Ob. When determining that any of the selected monitoring image data pieces shows the two eyes of the driver Ob, the image selection unit 1111 according to the second embodiment selects all the monitoring image data pieces showing the two eyes of the driver Ob in step S1111N, and stores these data pieces as the selected image data pieces into the selected image data storage 123 in the storage unit 12. The image selection unit 1111 then returns to step S1111A.

The image selection unit 1111 thus selects all the monitoring image data pieces each containing the two eyes of the driver Ob from the monitoring image data pieces captured by the driver cameras 21-1, 21-2, . . . , and 21-N, and stores these data pieces as the selected image data pieces into the selected image data storage 123.

When determining that none of the selected monitoring image data pieces shows the two eyes of the driver Ob in step S1111F, the image selection unit 1111 determines, as in the first embodiment, whether any of the selected monitoring image data pieces shows one eye of the driver Ob in step S1111I, among the monitoring image data pieces selected in step S1111C. When determining that any of the selected monitoring image data pieces shows one eye of the driver Ob, the image selection unit 1111 according to the second embodiment selects all the monitoring image data pieces showing one eye of the driver Ob, and stores these data pieces as the selected image data pieces into the selected image data storage 123 in step S1111O.

When determining that none of the monitoring image data pieces captured by the driver cameras 21-1, 21-2, . . . , and 21-N shows the two eyes of the driver Ob and finding one or more data pieces showing one eye of the driver Ob, the image selection unit 1111 selects all the monitoring image data pieces showing one eye of the driver Ob, and stores these data pieces as the selected image data pieces into the selected image data storage 123.

The image selection unit 1111 then determines whether the number of selected monitoring image data pieces is at least a predetermined number (M) in step S1111P. In the present embodiment, M is an integer smaller than N (the number of driver cameras), and greater than or equal to two. The value of M is set in the design stage of the system based on a trade-off between the reliability of the drowsiness estimation and the processing speed. When determining that at least the selected monitoring image data pieces is greater than or equal to the predetermined number in step S1111P, the image selection unit 1111 returns to step S1111A.

When determining that the number of selected monitoring image data pieces is not at least the predetermined number in step S1111P, the image selection unit 1111 selects one unselected image capturing the driver Ob with the face oriented closest to the front from the monitoring image data pieces captured by the driver cameras 21-1, 21-2, . . . , and 21-N and showing no eye of the driver Ob, and stores the selected single data piece as a selected image data piece into the selected image data storage 123 in step S1111Q. The image selection unit 1111 then advances to step S1111P and repeats the processing in steps S1111P and S1111Q until the number of selected monitoring image data pieces reaches the predetermined number. When the number of selected monitoring image data pieces reaches the predetermined number, the image selection unit 1111 returns to step S1111A.

When all the monitoring image data pieces showing one eye of the driver Ob have been selected but do not reach the predetermined number, the state estimation apparatus 1 further selects, from the images containing no eye of the driver Ob, one or more monitoring image data pieces in order from a monitoring image data piece capturing the driver Ob with the face oriented closer to the front to add up to the predetermined number, and stores these data pieces as the selected image data pieces into the selected image data storage 123.

When determining that the number of selected monitoring image data pieces is not at least the predetermined number in step S1111P, the image selection unit 1111 selects, in step S1111Q, one unselected image capturing the driver Ob with the face oriented closest to the front from the monitoring image data pieces captured by the driver cameras 21-1, 21-2, . . . , and 21-N and showing no eye of the driver Ob, and stores the selected one data piece as a selected image data piece into the selected image data storage 123. The image selection unit 1111 then advances to step S1111P and repeats the processing in steps S1111P and S1111Q until the number of selected monitoring image data pieces reaches least the predetermined number. After the number of selected monitoring image data pieces reaches the predetermined number, the image selection unit 1111 returns to step S1111A.

When finding no monitoring image data piece showing one or both eyes of the driver Ob, the state estimation apparatus 1 selects, from the monitoring image data pieces containing no eye of the driver Ob, the predetermined number of monitoring image data pieces in order from a monitoring image data piece capturing the driver Ob with the face oriented closer to the front. The state estimation apparatus 1 stores the data pieces as the selected image data pieces into the selected image data storage 123.

The image selection unit 1111 thus repeatedly selects all the monitoring image data pieces showing the two eyes of the driver Ob or a predetermined number of monitoring image data pieces showing one or no eye as the selected image data pieces to be used by the state estimation unit 1112, from the monitoring image data pieces stored in the monitoring image data storage 121 until the vehicle power system is turned off.

The state estimation unit 1112 can estimate the drowsiness in a reliable manner using the monitoring image data pieces showing the two eyes of the driver Ob. This eliminates the additional selection of monitoring image data pieces to reach the predetermined number. In some embodiments, monitoring image data pieces showing one or no eye of the driver Ob may be additionally selected to add up to the predetermined number.

### 2. Drowsiness Estimation

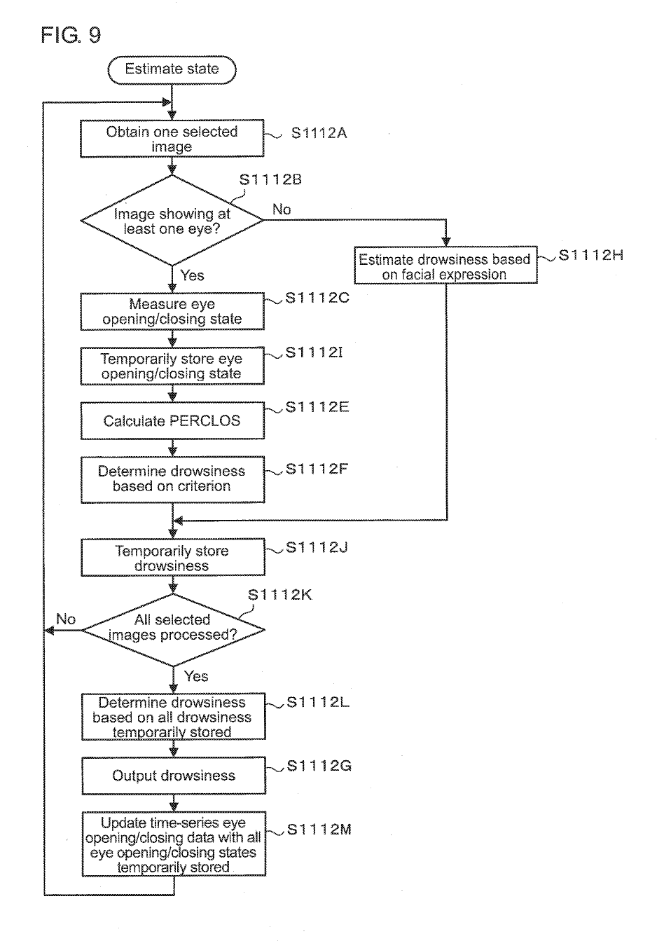

FIG. 9 is a flowchart showing the procedure and operation performed by the state estimation unit 1112 in the state estimation apparatus 1 shown in FIG. 7.

In step S1112A, the state estimation unit 1112 first obtains one of the selected image data pieces stored in the selected image data storage 123 in the storage unit 12. After the processing in steps S1112B and S1112C performed in the same manner as in the first embodiment using the obtained image data piece, the state estimation unit 1112 stores the eye opening/closing state of the driver Ob in step S1112I, which is the measurement result obtained in step S1112C, into the time-series eye state data storage 122 in the storage unit 12.

In step S1112E, the state estimation unit 1112 calculates PERCLOS as in the first embodiment. In the first embodiment, PERCLOS is calculated based on the time-series eye opening/closing data stored in the time-series eye state data storage 122. In the second embodiment, PERCLOS is calculated based on the time-series eye opening/closing data stored in the time-series eye state data storage 122, and the eye opening/closing state temporarily stored in the time-series eye state data storage 122. Unlike the time-series eye opening/closing data in the time-series eye state data storage 122 updated in step S1112D in the first embodiment, the time-series eye opening/closing data is not updated in the second embodiment. The time-series eye state data storage 122 thus stores the time-series data about the previous eye opening/closing state.

After calculating PERCLOS, the state estimation unit 1112 determines, as in the first embodiment, the drowsiness of the driver Ob in step S1112F, and then temporarily stores the drowsiness, which is the determination result, into the drowsiness temporary storage 124 in the storage unit 12 in step S1112J.

In step S1112K, the state estimation unit 1112 determines whether the processing on all the selected image data pieces stored in the selected image data storage 123 in the storage unit 12 is complete. When determining that the processing on all the selected image data pieces is not complete in step S1112K, the state estimation unit 1112 returns to step S1112A.

When determining that the selected image data piece shows no eye of the driver Ob in step S1112B, the state estimation unit 1112 performs the processing in step S1112H as in the first embodiment, and advances to step S1112J.

The state estimation unit 1112 thus estimates the drowsiness based on each of the selected image data pieces stored in the selected image data storage 123 in the storage unit 12. When determining that the processing on all the selected image data pieces is complete in step S1112K, the state estimation unit 1112 determines the final drowsiness using the drowsiness estimation results based on the selected image data pieces temporarily stored in the drowsiness temporary storage 124 in step S1112L. For example, the state estimation unit 1112 determines the final drowsiness by averaging the drowsiness estimation results based on the selected image data pieces or averaging the drowsiness estimation results using greater weights for drowsiness estimation results based on the selected image data pieces showing more eyes. The state estimation unit 1112 then outputs the determined drowsiness to the estimation state output unit 1113 in step S1112G as in the first embodiment.

In step S1112M, the state estimation unit 1112 updates the time-series eye opening/closing data stored in the time-series eye state data storage 122 using all the eye opening/closing states temporarily stored in the time-series eye state data storage 122. In this case as well, the state estimation unit 1112 updates the time-series eye opening/closing data after determining the final eye opening/closing state by averaging all the temporarily stored eye opening/closing states or averaging the eye opening/closing states using greater weights for the eye opening/closing states measured from the selected image data pieces showing more eyes. The state estimation unit 1112 then returns to step S1112A.

The state estimation unit 1112 thus repeatedly determines or estimates the drowsiness of the driver Ob based on the monitoring images selected by the image selection unit 1111 until the vehicle power system is turned off.

### 3. Drowsiness Output

The estimation state output unit 1113 determines whether the driver Ob is to be alerted based on the drowsiness determined or estimated by the state estimation unit 1112, and outputs the state estimation result information to the estimation result output device 3. The estimation result output device 3 thus provides the state estimation result information to the driver Ob by emitting an alert sound or lighting the alert lamp.

### Effects of Second Embodiment

In the state estimation apparatus 1 according to the embodiment described above, the image selection unit 1111 selects multiple monitoring image data pieces for the drowsiness estimation from multiple monitoring image data pieces about the vehicle driver Ob, which is a target person, captured by the multiple driver cameras 21-1, 21-2, . . . , and 21-N installed at different positions and stored in the monitoring image data storage 121 in the storage unit 12. The state estimation unit 1112 estimates the drowsiness of the driver Ob based on the selected monitoring image data pieces. The estimation state output unit 1113 outputs the state estimation result information indicating the estimated drowsiness of the driver Ob from the estimation result output device 3 to the driver Ob.

More specifically, the driver cameras 21-1, 21-2, . . . , and 21-N are installed to capture images of the driver Ob from different positions, and the image selection unit 1111 selects the monitoring image data pieces for the drowsiness estimation from the monitoring image data pieces about the driver Ob captured by these driver cameras 21-1, 21-2, . . . , and 21-N. The state estimation unit 1112 then estimates the drowsiness of the driver Ob based on the selected monitoring image data pieces, and the estimation state output unit 1113 outputs the state estimation result information indicating the estimation result to the estimation result output device 3. Although a monitoring image data piece about the driver Ob captured by one driver camera may not be used for the drowsiness estimation, a monitoring image data piece captured by another driver camera may be used for estimating the drowsiness of the driver Ob. The state estimation apparatus 1 can thus estimate the drowsiness of the driver Ob in any conditions in a stable manner.

In the state estimation apparatus 1, the image selection unit 1111 selects all the monitoring image data pieces each containing the two eyes of the driver Ob, and the state estimation unit 1112 estimates the drowsiness of the driver Ob based on each of the selected monitoring image data pieces to provide the average of the resultant estimates as an estimation result for the drowsiness of the driver Ob.

In this manner, the state estimation apparatus 1 estimates the drowsiness based on each monitoring image data piece containing the two eyes of the driver Ob, and provides the average of the resultant estimates as an estimation result for the drowsiness of the driver Ob. The state estimation apparatus 1 thus obtains a highly reliable final state estimation result.

In the state estimation apparatus 1, when finding no monitoring image data piece containing the two eyes of the driver Ob, the image selection unit 1111 selects all the monitoring image data pieces each containing one eye of the driver Ob. The state estimation unit 1112 estimates the drowsiness of the driver Ob based on each of the selected monitoring image data pieces, and provides the average of the resultant estimates as an estimation result for the drowsiness of the driver Ob.

In this manner, when finding no monitoring image data piece showing the two eyes of the driver Ob, the state estimation apparatus 1 estimates the target state based on each monitoring image data piece containing one eye of the driver Ob, and provides the average of the resultant estimates as an estimation result for the drowsiness of the driver Ob. The state estimation apparatus 1 thus obtains a more reliable state estimation result than an estimation result obtained from one monitoring image data piece containing one eye of the driver Ob.

In the state estimation apparatus 1, when the number of selected monitoring image data pieces is less than a predetermined number, the image selection unit 1111 further selects, from one or more monitoring image data pieces each containing no eye of the driver Ob, one or more monitoring image data pieces in order from a monitoring image data piece capturing the driver Ob with the face oriented closer to the front to add up to the predetermined number.

In this manner, when the number of monitoring images each containing one eye of the driver Ob is less than intended, the state estimation apparatus 1 further selects one or more monitoring image data pieces for state estimation in order from a monitoring image data piece capturing the driver Ob with the face oriented closer to the front. The state estimation apparatus 1 thus obtains a more reliable state estimation result than an estimation result obtained from one monitoring image data piece containing one eye of the driver Ob.

In the state estimation apparatus 1, when finding no monitoring image containing one or both eyes of the driver Ob, the image selection unit 1111 selects, from the monitoring image data pieces each containing no eye, the predetermined number of monitoring image data pieces in order from a monitoring image data piece capturing the driver Ob with the face oriented closer to the front.

In this manner, when finding no monitoring image containing one or both eyes of the driver Ob, the state estimation apparatus 1 selects, from the monitoring image data pieces each containing no eye, the predetermined number of monitoring image data pieces in order from a monitoring image data piece capturing the driver Ob with the face oriented closer to the front, and estimates the drowsiness of the driver Ob based on the selected data pieces. The state estimation apparatus 1 thus obtains a fairly reliable state estimation result based on the predetermined number of monitoring image data pieces appropriate for the drowsiness estimation using the facial expression of the driver Ob, selected from the monitoring image data pieces containing no eye of the driver Ob.

### Modifications

The embodiments of the present invention described in detail above are mere examples of the present invention in all respects. The embodiments may be variously modified or altered without departing from the scope of the present invention. More specifically, the present invention may be implemented as appropriate using the configuration specific to each embodiment.

(1) In the first and second embodiments, for example, the hidden eye state of the driver Ob is used as the criterion for selecting at least one image data piece from the multiple monitoring image data pieces about the driver Ob captured by the driver cameras 21-1, 21-2, . . . , and 21-N. In some embodiments, the hidden state of the mouth of the driver Ob may be additionally used as another criterion. A still other criterion may be added to or replace the above criterion.

The drowsiness of the driver Ob may be determined based on another index other than PERCLOS.

(2) In the first and second embodiments, the drowsiness is used as an example of the state of the driver Ob to be estimated. In some embodiments, another state such as distracted driving may be estimated.

(3) The target person may be other than the vehicle driver Ob. For example, the target person may be a driver or an operator of machinery used at manufacturing facilities or plants.

The present invention is not limited to the embodiments described above, but the components may be modified without departing from the spirit and scope of the invention. The components described in the above embodiments may be combined as appropriate to provide various aspects of the invention. For example, some of the components described in each embodiment described above may be eliminated. Further, components in different embodiments may be combined as appropriate.

### APPENDIXES

The embodiments described above may be partially or entirely expressed in, but not limited to, the following forms shown in the appendixes below.

### Appendix 1

A state estimation apparatus (1), comprising:

an image selection unit (1111) configured to select at least one monitoring image for use in estimating a state of a target person (Ob) from a plurality of monitoring images of the target person captured by a plurality of cameras (2-1, 2-2, . . . , and 2-N) placed at different positions;

a state estimation unit (1112) configured to estimate the state of the target person based on the selected monitoring image; and

an output unit (1113) configured to output information indicating an estimation result.

### Appendix 2

A state estimation method implemented by a state estimation apparatus (1) configured to estimate a state of a target person (Ob), the method comprising:

selecting, with the state estimation apparatus, at least one monitoring image for use in estimating the state of the target person from a plurality of monitoring images of the target person captured by a plurality of cameras (2-1, 2-2, . . . , and 2-N) placed at different positions;

estimating, with the state estimation apparatus, the state of the target person based on the selected monitoring image; and

outputting, with the state estimation apparatus, information indicating an estimation result.

### Appendix 3

A state estimation apparatus including a hardware processor (111) and a memory (112, 113), the hardware processor being configured to

select at least one monitoring image for use in estimating the state of the target person (Ob) from a plurality of monitoring images of the target person captured by a plurality of cameras (2-1, 2-2, . . . , and 2-N) placed at different positions;

estimate the state of the target person based on the selected monitoring image; and

output information indicating an estimation result.

### Appendix 4

A state estimation method implemented by an apparatus including a hardware processor (111) and a memory (112, 113), the method comprising:

selecting, with the hardware processor, at least one monitoring image for use in estimating the state of the target person (Ob) from a plurality of monitoring images of the target person captured by a plurality of cameras (2-1, 2-2, . . . , and 2-N) placed at different positions;

estimating, with the hardware processor, the state of the target person based on the selected monitoring image; and

outputting, with the hardware processor, information indicating an estimation result.

1. A state estimation apparatus, comprising:
an image selection unit configured to select at least one monitoring image for use in estimating a state of a target person from a plurality of monitoring images of the target person captured by a plurality of cameras placed at different positions;
a state estimation unit configured to estimate the state of the target person based on the selected monitoring image; and
an output unit configured to output information indicating an estimation result.

2. The state estimation apparatus according to claim 1, wherein
when selecting a plurality of the monitoring images, the image selection unit selects, from the plurality of selected monitoring images, one monitoring image capturing the target person with a face oriented closest to a front.

3. The state estimation apparatus according to claim 1, wherein
the image selection unit selects a monitoring image containing a face of the target person from the plurality of monitoring images.

4. The state estimation apparatus according to claim 3, wherein
when selecting a plurality of the monitoring images, the image selection unit selects, from the plurality of selected monitoring images, one monitoring image capturing the target person with a face oriented closest to a front.

5. The state estimation apparatus according to claim 1, wherein
the image selection unit selects a monitoring image containing an eye of the target person from the plurality of monitoring images.

6. The state estimation apparatus according to claim 5, wherein
when selecting a plurality of the monitoring images, the image selection unit selects, from the plurality of selected monitoring images, one monitoring image capturing the target person with a face oriented closest to a front.

7. The state estimation apparatus according to claim 1, wherein
the image selection unit selects a monitoring image containing two eyes of the target person from the plurality of monitoring images.

8. The state estimation apparatus according to claim 7, wherein
when selecting a plurality of the monitoring images, the image selection unit selects, from the plurality of selected monitoring images, one monitoring image capturing the target person with a face oriented closest to a front.

9. The state estimation apparatus according to claim 1, wherein
the image selection unit selects all monitoring images each containing two eyes of the target person, and
the state estimation unit estimates the state of the target person based on each of the selected monitoring images, and provides an average of resultant estimates as an estimation result for the state of the target person.

10. The state estimation apparatus according to claim 1, wherein
when finding no monitoring image containing two eyes of the target person, the image selection unit selects all monitoring images each containing one eye of the target person, and
the state estimation unit estimates the state of the target person based on each of the selected monitoring images, and provides an average of resultant estimates as an estimation result for the state of the target person.

11. The state estimation apparatus according to claim 10, wherein
when the number of selected monitoring images is less than a predetermined number, the image selection unit further selects, from the monitoring images each containing no eye of the target person, one or more monitoring images in order from a monitoring image capturing the target person with a face oriented closer to a front to add up to the predetermined number.

12. The state estimation apparatus according to claim 1, wherein
when finding no monitoring image containing an eye or two eyes of the target person, the image selection unit selects, from the monitoring images each containing no eye of the target person, a predetermined number of monitoring images in order from a monitoring image capturing the target person with a face oriented closer to a front.

13. A state estimation method implemented by a state estimation apparatus configured to estimate a state of a target person, the method comprising:
selecting, with the state estimation apparatus, at least one monitoring image for use in estimating the state of the target person from a plurality of monitoring images of the target person captured by a plurality of cameras placed at different positions;
estimating, with the state estimation apparatus, the state of the target person based on the selected monitoring image; and
outputting, with the state estimation apparatus, information indicating an estimation result.

14. A non-transitory recording medium having a state estimation program recorded thereon, the state estimation program causing a computer to function as the units included in the state estimation apparatus according to claim 1.
